(19) United States
(12) Patent Application Publication
(10) Pub. No.: US 2026/0162952 A1
(43) Pub. Date: Jun. 11, 2026

(54) SYSTEMS AND METHODS FOR LOSSLESS ION MOBILITY SPECTROMENTER WITH AXIAL DIFFUSION CONSTRICTION

(71) Applicant: Purdue Research Foundation, West Lafayette, IN (US)

(72) Inventor: Carlos Larriba-Andaluz, West Lafayette, IN (US)

(21) Appl. No.: 19/408,472

(22) Filed: Dec. 4, 2025

Related U.S. Application Data
(60) Provisional application No. 63/728,795, filed on Dec. 6, 2024.

(51) Int. Cl. H01J 49/36; H01J 49/00

(52) U.S. Cl. CPC H01J 49/36; H01J 49/0031

(57) ABSTRACT

The invention generally relates to system and method for lossless ion mobility spectrometer with axial diffusion constriction. In certain aspects, the invention provides an ion mobility spectrometry system, the system comprising: an ion mobility drift cell comprising electrodes; and a central processing unit (CPU), and storage coupled to the CPU for storing instructions that when executed by the CPU cause the electrodes of the drift cell to apply varying electric fields within the drift cell to constrain ions as they get separated in the drift cell and thereby restrict axial diffusion of the ions in the drift cell.

### RELATED APPLICATION

The present application claims the benefit of and priority to U.S. provisional patent application Ser. No. 63/728,795, filed Dec. 6, 2024, the content of which is incorporated by reference herein in its entirety.

### FIELD OF THE INVENTION

The invention generally relates to system and method for lossless ion mobility spectrometer with axial diffusion constriction.

### BACKGROUND

Ion mobility-mass spectrometry (IM-MS) is a technique that in recent years has gained a considerable amount of interest for clinical diagnostics, especially in improving the molecular characterization of complex biological samples. This innovative technique allows separating ions not only based on their charge and mass-to-charge ratio but also on shape and size, offering a proficient method for differentiating isomeric compounds, hence molecules that present the same chemical formula but with different structural arrangements. Traditional mass spectrometry often cannot identify these isomers, which makes IM-MS such an important tool in surmounting this problem. As ion mobility resolving power continues to improve, the speed and accuracy of IM-MS in high-throughput analyses will continue to grow, especially in metabolomics and lipidomics areas where high-throughput identification with real precision at the molecular level is desired or required. Besides its use for the identification of molecules, IM-MS greatly enhances detailed spatial mapping of molecular distributions in tissue samples. Such an aspect would be of critical importance during surgery, in which real-time analyses can inform crucial decisions on tumor margins and biomarker identification. Such rapid obtention of detailed information is important in observing better outcomes for patients, as such information enables health professionals to make informed decisions during the procedure. Moreover, incorporation of IM-MS into workflows ensures speedy delivery of data in support of timely intervention in patient care. Needless to say, with its constant upgrading, the potential in IM-MS for routine clinical applications can be huge, both in real-time and bench-type analyses. IM is already fast enough (ms) for routine clinical, but it must improve in selectivity and sensitivity if it is to be incorporated in routine applications or to become a standalone forensic tool.

### SUMMARY

The invention recognizes that one of the issues that prevents IM from achieving higher resolution is that molecular ions tend to diffuse in the gas phase, broadening its peak signal and eventually making it indistinguishable from noise (See FIG. 1). To that end, aspects of the the invention provide systems and methods that restrict axial diffusion through the use of varying electric fields that constrain ions as they get separated. Theoretical and instrumental advances proposed herein will allow us to use the varying field postulation on the Structure for Lossless Manipulation (SLIM) systems, a novel IM technique which allows ions to be cycled, producing much higher resolutions. Without being limited by any theory or mechanism of action, we believe that if the varying field approach can be implemented in SLIM, it will offer quasi-infinite resolution, meaning that any two small molecules can be baseline separated as long as they interact with the gas differently, regardless of mass and/or structure. For example, isotopologues or cis-trans isomers would be readily separable by IM alone. It is also believed that it would be useful for the use of the varying field optimally within a miniaturized the system, so reducing its size and complexity would be an ancillary goal that would make it more portable and adequate for a clinical setting.

In certain aspects, the invention provides an ion mobility spectrometry system, the system comprising: an ion mobility drift cell comprising electrodes; and a central processing unit (CPU), and storage coupled to the CPU for storing instructions that when executed by the CPU cause the electrodes of the drift cell to apply varying electric fields within the drift cell to constrain ions as they get separated in the drift cell and thereby restrict axial diffusion of the ions in the drift cell.

On other aspects, the invention provides a method of separating ions while restricting axial diffusion of the ions, the method comprising: generating a plurality of ions that are transferred to an ion mobility spectrometer comprising an ion mobility drift cell comprising electrodes; and applying, via a central processing unit (CPU) of the ion mobility spectrometer, varying electric fields within the drift cell to constrain the plurality of ions as they get separated in the drift cell and thereby restrict axial diffusion of the plurality of ions in the drift cell.

In certain embodiments of the systems and methods of the invention, a moving transversal square wave (T-wave) provides the varying electric fields. In certain embodiments of the systems and methods of the invention, the varying electric fields are applied in a manner to produce a linearly decreasing electric field. In certain embodiments of the systems and methods of the invention, the square T-wave has a period and a translating frequency that allows the ions to be pushed constantly forward as the ions spend more time on a crest of the square T-wave than on a trough of the square T-wave.

In certain embodiments of the systems and methods of the invention, the electrodes are arranged in an alternating format along the drift cell. In certain embodiments of the systems and methods of the invention, the drift cell comprises at least 8 electrodes, 16 electrodes, or 32 electrodes. In certain embodiments of the systems and methods of the invention, a center-to-center distance of the alternating electrodes is at least 0.5 mm. In certain embodiments of the systems and methods of the invention, the a center-to-center distance of the alternating electrodes between 1.0 mm to 1.5 mm. In certain embodiments of the systems and methods of the invention, the a center-to-center distance of the alternating electrodes is 1.2 mm. In certain embodiments of the systems and methods of the invention, electrodes are located on two SLIM boards.

The new improvements provides by the systems and methods of the invention will position IM-MS as one of the main future contributors to healthcare by enhancing diagnostics, monitoring of diseases, and personalized treatment strategies. Furthermore, since this technique responds to problems in molecular analysis from a clinical perspective, IM-MS may mean the beginning of changes in the way diagnostics and management of patients will be approached.

### BRIEF DESCRIPTION OF THE DRAWINGS

FIG. 1 shows a depiction of diffusion autocorrection.

FIG. 2A shows (i) sketch of the variation of the field through the drift tube clarifying the effect of diffusion correction; and (ii) that over time, a distribution of particles can be narrowed down in the axial direction. FIGS. 2B and 2C show simulation of the distributions (Right).

FIG. 3 shows a transversal wave on an instrument showing the electric field pushing the ions axially.

FIG. 4 (left) Drawing of the SLIM board depicting the electrodes. (middle) Picture of two boards put together. (right) Different wave pattern voltages applied.

FIG. 5 (left) Simion simplified board. (right) Electric field patterns at the center (2 mm away from each board) in the x direction.

FIG. 6 shows a proposed ideal electric field wave pattern composed of a fast rise followed by a very slow fall where most of the constriction will occur.

FIG. 7 (Top) Simion design with the boards at a distance of 1.2 mm. (Bottom) Axial Electric field as a function of the distance at the center (blue line) and 0.5 mm off center (orange line).

FIG. 8 shows an embodiment of a geometry to be refined as the project continues. This geometry, subject to a quadratic voltage wave (blue line) yields an electric field that is linearly decreasing for most of the wave-period.

FIG. 9 is an illustration showing an exemplary data analysis module for implementing the systems and methods of the invention in certain embodiments.

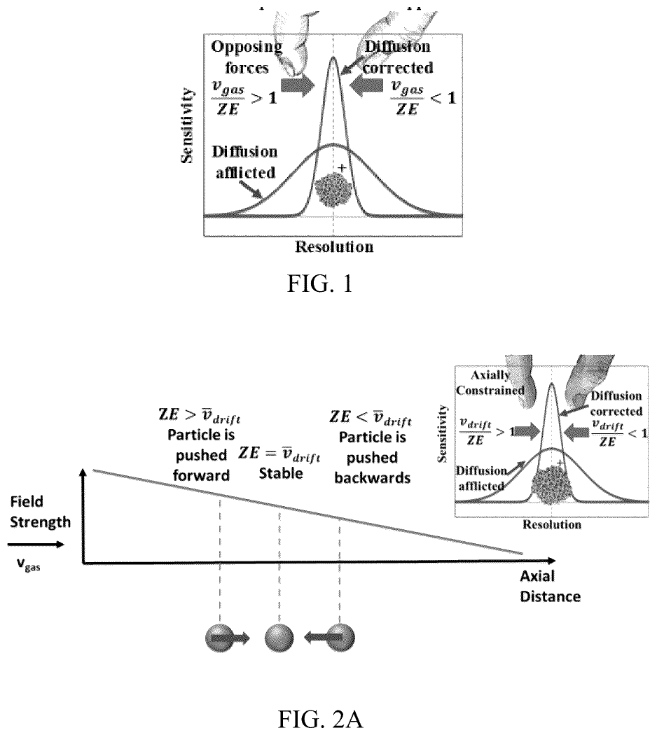

### DETAILED DESCRIPTION

Ion Mobility Spectrometry (IMS) has become a ubiquitous analytical chemistry tool to separate ions in the gas phase. Its principle relies on the fact that dissimilar ions under the influence of an electric field interact differently with gas molecules, leading to distinct drift velocities that separate the ions' arrival to a detector. The technology has evolved greatly in the recent years to the point that even isotopomers, molecules with same mass, same structure, and only different location of the isotopic substitutions, have been separated due to the fact that they rotate differently upon collisions with the gas phase. This capability, together with its separation speed (in the order of milliseconds), portability and its sensitivity, makes this technology very appealing to real time forensics, environmental monitoring, drug development, and industrial process control.

While the technique is advancing at an accelerated pace, IMS still has potential drawbacks. Among these drawbacks, one can name poor selectivity, which can produce false alarms, or the need to confirm the analytes with a hyphenated technique such as a Mass Spectrometer. A major issue with selectivity and sensitivity is that ions tend to diffuse in the gas phase. Radial diffusion has been recently suppressed through the use of Radio Frequency (RF) at low pressures confining the ions to a lossless tube. This allows ions to cycle indefinitely in instruments such as the Waters Cyclic IMS or the Structure for Lossless Ion Manipulation (SLIM) system. However, controlling diffusion axially is more difficult since systems require a driving mechanism for the ions to traverse the IMS cell that inhibits control. Axial diffusion causes the swarm of ions to broaden with the passage of time leading to loss of signal to noise (S/N) and eventual total sensitivity loss if the ions are cycled too long.

If axial diffusion were to be halted or at least mitigated it would be completely transformative, as ions could be left cycling indefinitely without S/N loss. Achieving this technology would be drastic, with selectivity rivaling that of the best Mass Spectrometers, with the advantage of being portable. It would have groundbreaking proposal in clinical settings, enabling real-time, high precision molecular analysis. It could distinguish between isotopologues, structural isomers or post-translational modifications. It would be a non-invasive technique with instant diagnostic results from real-time analysis, (e.g., for metabolic disorders, breath analysis, urine analysis, etc.). It could be used for precision medicine allowing detection of very small quantities, tailoring treatments to molecular characteristics of a disease, such as cancer mutations or pathogen variants. Its ease of hyphenation with other techniques would make, together with Artificial Intelligence and Machine Learning, characterization of any compound fast and automated, reducing human error and increasing throughput of diagnostic facilities. Here, we intend to propose a mechanism for which diffusion constriction is possible for undefined path lengths and to build a prototype to be tested.

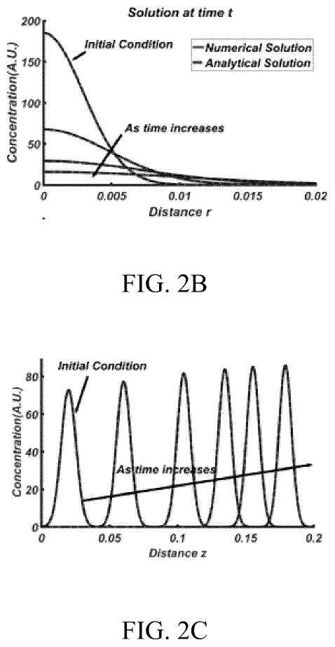

An ion swarm in an IM drift cell is guided and separated by the electric field inside. The drift velocity of an ion inside is given by the product of the mobility Z (sometimes called K) and the electric field E so that an average velocity may be given by v̅_{drift}=ZE. It is the different drifts that separate the ions. Contiguously to their drift, ions diffuse in all directions causing the ion package to broaden. Restricting the diffusion radially is manageable by RF, but doing so axially is rather complicated. There are possible ways in which ion diffusion can be restricted axially. The most common one is that proposed by our group where a linearly decreasing field may be used for restriction. Imagine a swarm of ions traveling with an average drift v̅_{drift}=ZE as shown in FIG. 2A. If a particular ion were to diffuse backwards as it travels, the ion would see a higher electric field so that ZE>V v̅_{drift} gaining velocity over the average drift and catching up. On the contrary, if the ion were to diffuse forward, it would see a lower electric field ZE<v̅_{drift} and the ion would slow down letting the swarm catch up to it. This will cause axial diffusion constriction.

Simulations of the ion swarm distribution subject to the linearly decaying field are shown to the right of FIGS. 2B-C in the radial and axial directions. Even with an initially broad distribution, the distribution becomes axially narrower with distance (See FIG. 2C). The radial direction (FIG. 2B) still suffers from diffusion which can be mitigated by the RF. The issue with this method is that the voltage to produce a linearly decreasing field is quadratic with distance, meaning that the electrical voltage to produce a reasonable electric field would be in the thousands in just a few centimeters, precluding its use in high-resolution systems that can be cycled. The idea is nonetheless worth pursuing further if one were able to find a way to provide a similar linear decreasing field for the full length required to separate analytes.

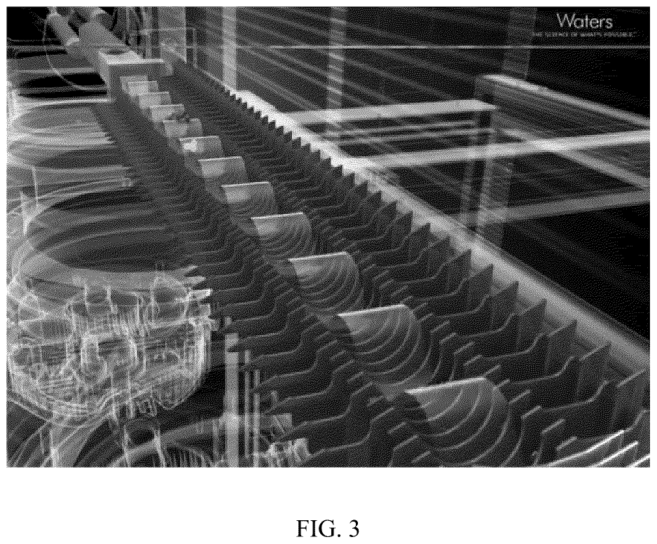

Cyclic IMS systems and/or SLIM systems use a moving transversal square wave (T-wave) that provides a varying electric field that pushes the ions axially as seen in FIG. 3. The square T-wave has a period and a translating frequency that allows the ion to be pushed constantly forward as the ion spends more time on the crest of the wave than on the trough. Given sufficient time and distance of travel, ions with different drift velocities may be separated. One of the main reasons for using a T-wave is that it requires low voltages to produce significant fields (fast voltage gradients produce large fields) and can be used for indefinitely long paths, or until the S/N ratio is so small that there is no way to distinguish the peaks.

The innovative approach therefore in this proposal is to couple the diffusion constriction idea with infinitely long paths yielding what would be a quasi-infinite resolution system that would completely revolutionize the field of analytical chemistry. As will be shown in the approach section, creating a train of diffusion constricting waves that is lossless is not as simple as it may seem and comes with potential risks. Furthermore, miniaturizing the system would be extremely beneficial as it would increase its portability allowing it to be used in clinical settings and for real time forensic and diagnostic analyses.

The invention provides aspects and simulations for diffusion constriction in a SLIM system as well as construction of a compact Constricted Lossless Ion Mobility Board (CLIMB).

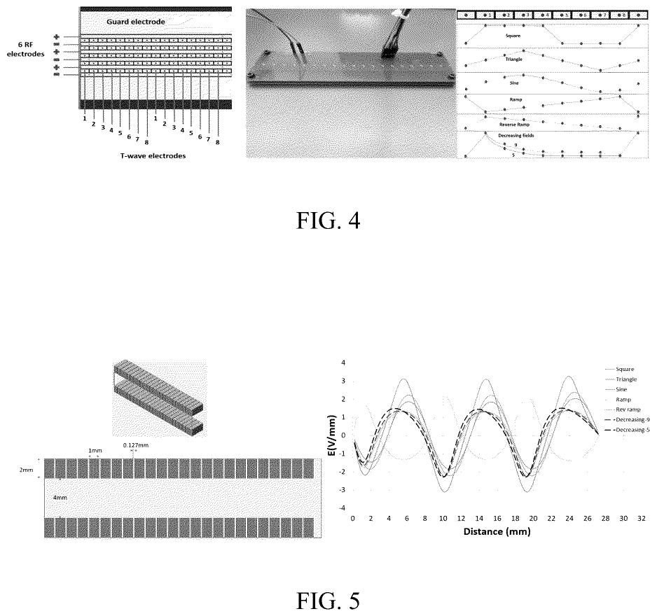

The study of diffusion constriction requires an initial analysis of the SLIM platform. A typical SLIM is shown in FIG. 4. It is composed of two mirrored boards separated by a gap of around 4 mm (middle of figure). Each slim board contains a series of alternated electrodes (left of figure), with center-to-center distance of approximately 0.53 mm (between tracks), which provide the RF and the T-wave voltage while two broader DC guards are used for ion confinement in the transversal direction to the boards. RF voltages are applied 180 degrees out of phase alternatively to the strip electrodes (unsegmented ones). A Traveling wave (T-wave) consists of a set defined by 8 electrodes whose voltage is modified dynamically, and which enables the ion motion axially. The T-wave patterns can be varied in terms of amplitude and frequency (speed). For example, the T-wave velocity is determined by the total length of the 8 electrodes (9.14 mm) multiplied by T-wave frequency (standard is ˜10 kHz). The 8 electrodes may have a series of voltages applied to it so that different wave patterns may be applied. An example of such patterns may be observed to the right of FIG. 4 although the square wave pattern is the most commonly employed.

In simple terms, one would expect that using the decreasing voltage pattern in FIG. 4 (bottom right) would yield a decreasing electric field compatible with diffusion constriction. However, there are two important issues that arise that would make that choice not suitable. The first one is that the raise in voltage from electrodes 8 to 1 would provide a linearly increasing electric field with the opposite effect to constriction, i.e. causing “diffusion intensification”, and the second is that the electric field at the center between the two boards is greatly deformed and no longer providing sufficient diffusion constriction.

For the latter, FIG. 5 depicts the electric fields at the center between the two boards calculated using a SIMION simulation for all the wave patterns shown in FIG. 4. Despite the very different voltages applied, the reality is that the electric field is quite similar in nature for all the wave patterns (some are slightly better than others) but none offer the expected linearly decaying field for most of the wave period, which would be required for axial constriction. In fact, the large portion of positive slope in the field would enhance diffusion, as previously mentioned.

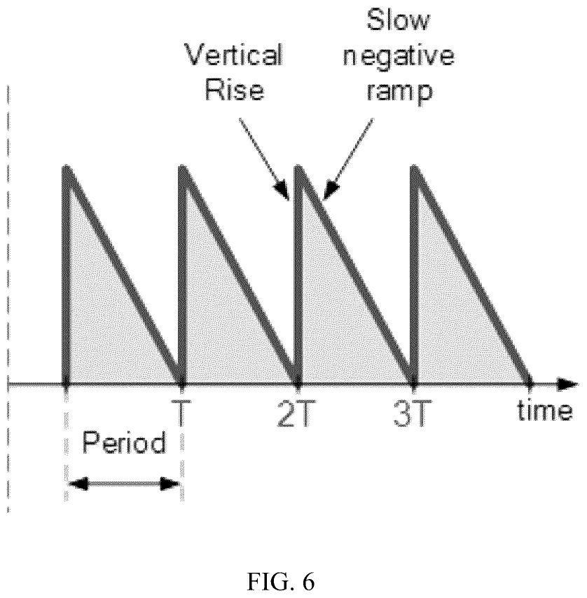

The positive slope is an inherent problem derived from the fact that our wave pattern must be irrevocably repeated. This leads us to the first issue which promotes the question of how problematic the positive slope is and if there is a way to mitigate the effect. The idea, assuming one can provide an optimal electric field, is to study if the constriction effect from the decreasing field can overcome not only diffusion but also the intensification effect of the positive field. One of the ways this can be done is by theoretically and/or numerically solving the Nernst-Planck equation in the axial z and radial r directions as a function of time t. If the ion's mobility is Z, its diffusion is D and its concentration is n(z,r,t), then the balance equation is given by:

$$\frac{\partial n ( z , r , t )}{\partial t} - ∇ \cdot ( \overline{\overline{D}} \cdot ∇ n ( z , r , t ) = - Z \vec{E} n ( z , r , t ) ) = 0 \qquad ( 1 )$$

where E is the electric field provided by FIG. 6. When subject to Gaussian axial-symmetric initial conditions, the general solution to this equation is given by:

$$n ( z , r , t ) = \frac{{n}_{s}}{{( 2 π )}^{\frac{3}{2}} \sqrt{{σ}_{z}^{2}} {σ}_{r}^{2}} {e}^{- \frac{{( z - \overline{z} )}^{2}}{2 {σ}_{Z}^{2}}} {e}^{- \frac{{r}^{2}}{2 {σ}_{r}^{2}}} \qquad ( 2 )$$

Here ns is the initial ion concentration, z̅(t) is the average ion swarm center position in the axial direction as time passes, and σ_{z}(t) and σᵣ(t) are the axial and radial standard deviations respectively. Without going into unnecessary details about eq. (2), which can be solved numerically or analytically, our focus lies on the axial standard deviation σ_{z}(t) of the solution as it will let us know if the distribution is becoming broader or narrower as a function of time and therefore if constriction is achieved. FIG. 6 explores the ideality of a train of electrical field wave patterns composed of an acute vertical rise and a slow negative (linearly decreasing) ramp. By using this proposed electric field E in eq. (1) one should be able obtain a standard deviation σ_{z}(t) that depends on the two slopes as a function of time. If the distribution does not widen or it widens less than regular diffusion, then constriction will have worked. Under static wave conditions (velocity of the wave is zero), it seems that the ratio between the slopes Aᵣᵢₛₑ/A_{fall}>20 for the idea to work successfully. This makes sense, as it would spend very little time on the raising edge and more time on the falling edge where constriction happens. Moreover, when the wave is moving with a velocity, the residence time on the crest of the wave would be much higher than on the trough, since both ion and wave are moving in the same direction, making requirement of the Aᵣᵢₛₑ/A_{fall} ratio much lower and proportional to the wave velocity, which suggests constriction functioning under much worse scenarios than predicted here.

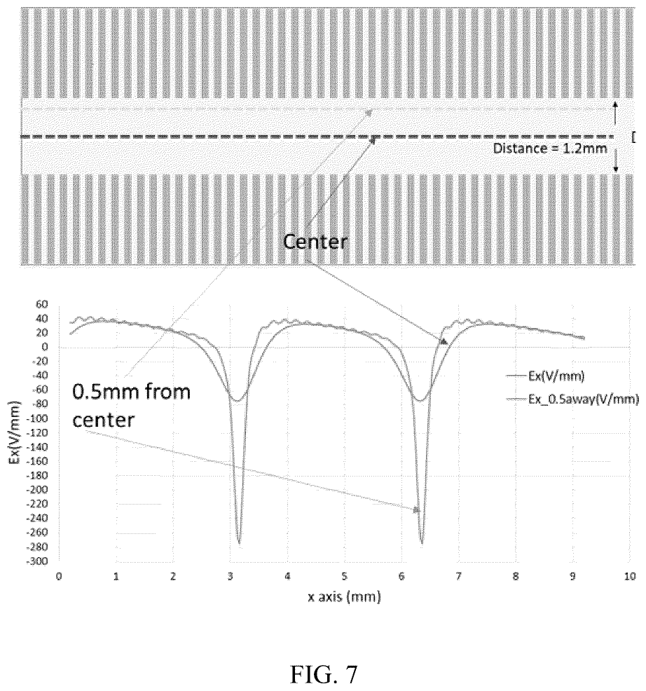

Next is provided a design of a system that can shows electrical field that may be involved with the systems and methods of the invention. As shown in FIG. 5, existing SLIM platforms deform the electric field yielding a quasi-sinusoidal curve which would not satisfy the requirements. Under one-dimensional considerations, the voltage applied in the decreasing ramps should provide a linearly decreasing field and hence getting closer to a one-dimensional regime would help achieve our goal. As such, a possible solution is to make the distance between the two boards smaller. A Simion simulation using a distance of 1.2 mm between the two SLIM boards is shown in FIG. 7. The top figure shows the design while the bottom figure displays the axial electric field as a function of the distance at the center (blue line) and at 0.5 mm off center (orange line). The results with such a small change are quite promising since, at the center, one can already see that the shape starts to resemble a linearly decreasing field. Moreover, closer to the electrodes, the shape is even more encouraging which suggests that an even narrower gap between the boards might be preferable. A couple of things can be noted here. The first is that the large negative field created is not problematic since the ion will spend almost no time (more time on the autocorrecting side) as, in this region, it travels backwards while the wave travels forward. The ripple shown close to the electrode is only present due to the spacing between the electrodes which can be corrected. To improve the shape, 16 or even 32 electrodes instead of 8 may be used for the characterization of the wave pattern allowing a larger Aᵣᵢₛₑ/A_{fall} slope difference. Finally, the difference between the center and off-center fields can be corrected by increasing the width or further reducing the distance between the boards.

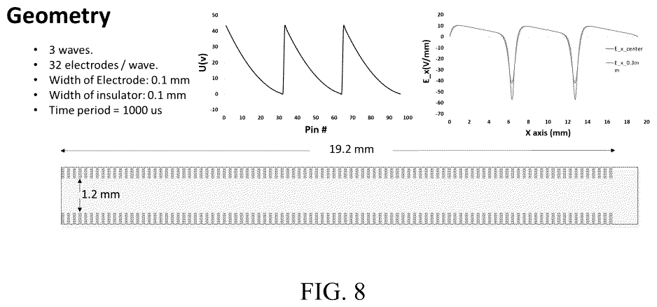

With these goals in mind, a newer board was simulated as shown in FIG. 8, in which the gap between the two boards remains at 1.2 mm (although it could easily be made smaller) while the length of the electrodes as well as the gaps between them is kept at 0.1 mm. Traces of 0.025 mm can be accommodated nowadays in printed circuit boards although at a considerable price. Meanwhile, the RF guides should remain wide enough to not cause issues. FIG. 8 shows a section of the board composed of 96 electrodes constituting three total waves of 32 electrodes each. The center graph showcases the voltage for each pin in blue while the right graph depicts the axial electrical field at the center and off-center as a function of distance. The new geometry is quite promising with the linearly decreasing field corresponding to approximately 92% of the total period, which could easily become more than 98% at the right wave frequency.

### System Architecture

In certain embodiments, the systems and methods of the invention can be carried out using automated systems and computing devices. Specifically, aspects of the invention described herein can be performed using any type of computing device, such as a computer, that includes a processor, e.g., a central processing unit, or any combination of computing devices where each device performs at least part of the process or method. In some embodiments, systems and methods described herein may be controlled using a handheld device, e.g., a smart tablet, or a smart phone, or a specialty device produced for the system.

Systems and methods of the invention can be performed using software, hardware, firmware, hardwiring, or combinations of any of these. Features implementing functions can also be physically located at various positions, including being distributed such that portions of functions are implemented at different physical locations (e.g., imaging apparatus in one room and host workstation in another, or in separate buildings, for example, with wireless or wired connections).

Processors suitable for the execution of computer program include, by way of example, both general and special purpose microprocessors, and any one or more processor of any kind of digital computer. Generally, a processor will receive instructions and data from a read-only memory or a random access memory or both. The essential elements of computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, solid state drive (SSD), and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having an I/O device, e.g., a CRT, LCD, LED, or projection device for displaying information to the user and an input or output device such as a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected through network by any form or medium of digital data communication, e.g., a communication network. For example, the reference set of data may be stored at a remote location and the computer communicates across a network to access the reference set to compare data derived from the female subject to the reference set. In other embodiments, however, the reference set is stored locally within the computer and the computer accesses the reference set within the CPU to compare subject data to the reference set. Examples of communication networks include cell network (e.g., 3G or 4G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, Perl), and it can be deployed in any form, including as a stand-alone program or as a module, component, subroutine, or other unit suitable for use in a computing environment. Systems and methods of the invention can include instructions written in any suitable programming language known in the art, including, without limitation, C, C++, Perl, Java, ActiveX, HTML5, Visual Basic, or JavaScript.

A computer program does not necessarily correspond to a file. A program can be stored in a file or a portion of file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over a network (e.g., as packets being sent from a server to a client, for example, through a Network Interface Card, modem, wireless card, or similar).

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user. In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file are well-known in the art and, for example, can be invoked manually or automatically by a program or by a save command from software or a write command from a programming language.

Suitable computing devices typically include mass memory, at least one graphical user interface, at least one display device, and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (DVD) or other optical storage, magnetic cassettes, magnetic tape, magnetic disk storage or other magnetic storage devices, Radiofrequency Identification tags or chips, or any other medium which can be used to store the desired information and which can be accessed by a computing device.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

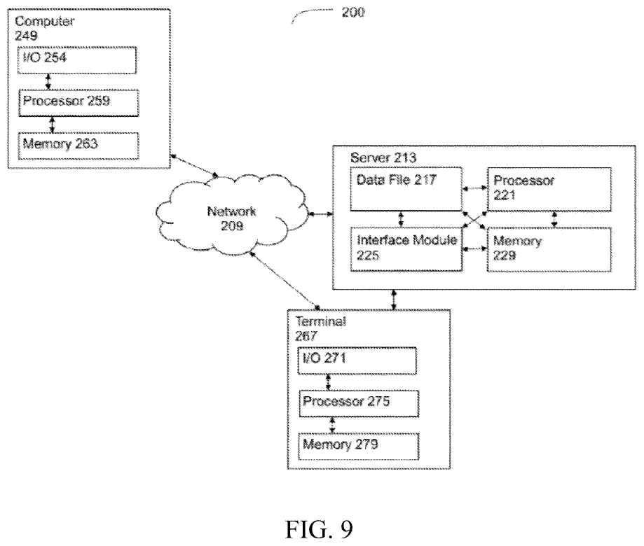

In an exemplary embodiment shown in FIG. 9, system 200 can include a computer 249 (e.g., laptop, desktop, or tablet). The computer 249 may be configured to communicate across a network 209. Computer 249 includes one or more processor 259 and memory 263 as well as an input/output mechanism 254. Where methods of the invention employ a client/server architecture, steps of methods of the invention may be performed using server 213, which includes one or more of processor 221 and memory 229, capable of obtaining data, instructions, etc., or providing results via interface module 225 or providing results as a file 217. Server 213 may be engaged over network 209 through computer 249 or terminal 267, or server 213 may be directly connected to terminal 267, including one or more processor 275 and memory 279, as well as input/output mechanism 271.

System 200 or machines according to the invention may further include, for any of I/O 249, 237, or 271 a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Memory 263, 279, or 229 according to the invention can include a machine-readable medium on which is stored one or more sets of instructions (e.g., software) embodying any one or more of the methodologies or functions described herein. The software may also reside, completely or at least partially, within the main memory and/or within the processor during execution thereof by the computer system, the main memory and the processor also constituting machine-readable media. The software may further be transmitted or received over a network via the network interface device.

### INCORPORATION BY REFERENCE

References and citations to other documents, such as patents, patent applications, patent publications, journals, books, papers, web contents, have been made throughout this disclosure, including to the Supplementary. The Supplementary, and all other such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

What is claimed is:

1. An ion mobility spectrometry system, the system comprising:
an ion mobility drift cell comprising electrodes; and
a central processing unit (CPU), and storage coupled to the CPU for storing instructions that when executed by the CPU cause the electrodes of the drift cell to apply varying electric fields within the drift cell to constrain ions as they get separated in the drift cell and thereby restrict axial diffusion of the ions in the drift cell.

2. The system of claim 1, wherein a moving transversal square wave (T-wave) provides the varying electric fields.

3. The system of claim 2, wherein the varying electric fields are applied in a manner to produce a linearly decreasing electric field.

4. The system of claim 2, wherein the square T-wave has a period and a translating frequency that allows the ions to be pushed constantly forward as the ions spend more time on a crest of the square T-wave than on a trough of the square T-wave.

5. The system of claim 1, wherein the electrodes are arranged in an alternating format along the drift cell.

6. The system of claim 5, wherein the drift cell comprises at least 8 electrodes, 16 electrodes, or 32 electrodes.

7. The system of claim 5, wherein a center-to-center distance of the alternating electrodes is at least 0.5 mm.

8. The system of claim 7, wherein the a center-to-center distance of the alternating electrodes between 1.0 mm to 1.5 mm.

9. The system of claim 8, wherein the a center-to-center distance of the alternating electrodes is 1.2 mm.

10. The system of claim 9, wherein electrodes are located on two SLIM boards.

11. A method of separating ions while restricting axial diffusion of the ions, the method comprising:
generating a plurality of ions that are transferred to an ion mobility spectrometer comprising an ion mobility drift cell comprising electrodes; and
applying, via a central processing unit (CPU) of the ion mobility spectrometer, varying electric fields within the drift cell to constrain the plurality of ions as they get separated in the drift cell and thereby restrict axial diffusion of the plurality of ions in the drift cell.

12. The method of claim 11, wherein a moving transversal square wave (T-wave) provides the varying electric fields.

13. The method of claim 12, wherein the varying electric fields are applied in a manner to produce a linearly decreasing electric field.

14. The method of claim 12, wherein the square T-wave has a period and a translating frequency that allows the ions to be pushed constantly forward as the ions spend more time on a crest of the square T-wave than on a trough of the square T-wave.

15. The method of claim 11, wherein the electrodes are arranged in an alternating format along the drift cell.

16. The method of claim 15, wherein the drift cell comprises at least 8 electrodes, 16 electrodes, or 32 electrodes.

17. The method of claim 15, wherein a center-to-center distance of the alternating electrodes is at least 0.5 mm.

18. The method of claim 17, wherein the a center-to-center distance of the alternating electrodes between 1.0 mm to 1.5 mm.

19. The method of claim 18, wherein the a center-to-center distance of the alternating electrodes is 1.2 mm.

20. The method of claim 19, wherein electrodes are located on two SLIM boards.
